(19) United States
(12) Patent Application Publication
(10) Pub. No.: US 2009/0060056 A1
(43) Pub. Date: Mar. 5, 2009

(54) METHOD AND APPARATUS FOR CONCEALING ERRORS IN A VIDEO DECODING PROCESS

(75) Inventor: Daqing Zhang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,245

(22) PCT Filed: Oct. 20, 2005
(86) PCT No.: PCT/IB05/53434

§ 371 Date: Apr. 30, 2007

(30) Foreign Application Priority Data
Nov. 4, 2004 (CN) 200410092533.3

(51) Int. Cl. H04N 7/68

(52) U.S. Cl. 375/240.27; 375/E07.281

(57) ABSTRACT

A method for concealing errors in a video decoding process according to the invention, wherein said method comprises the steps of: receiving a frame of video picture comprising an comprising an error-existing picture area and a neighboring picture area; searching a similar picture area to said neighboring picture area according to a predetermined condition in a frame of reference picture of said video picture; concealing said existing errors by using the information in said video picture if said similar picture area is not found, or concealing said existing errors by using the information in said reference picture if said similar picture area is found.

### FIELD OF THE INVENTION

The present invention relates to a method and apparatus for concealing errors in video pictures, more particularly to a method and apparatus for concealing errors in a video decoding process.

### BACKGROUND OF THE INVENTION

Video pictures usually comprise the I-frame picture (Intra-coded picture), P-frame picture (Predicted picture) and B-frame picture (Bidirectional or bi-directionally predicted picture). Wherein the I-frame picture is encoded without referring to other pictures and comprises the necessary information required for decoding and recomposing itself, so its compression ratio is very low. The P-frame picture is obtained through encoding the P-frame picture or I-frame picture by means of the motion compensated prediction technique, and its compression ratio is much higher than that of the I-frame picture. The B-frame picture is obtained through bidirectional interpolation encoding between the P-frame picture and I-frame picture and has the highest compression ratio, and encoding errors in the B-frame picture will not spread to other pictures.

During a video decoding process, the quality of video output will decrease if there are too many error-existing picture areas (for example erroneous Macro-block, erroneous Slice, etc.) in video pictures, and it'll even affect users' interest in watching. Therefore, it is quite necessary to conceal errors in error-existing picture areas so as to increase the video output quality and improve users' interest in watching when errors occur in video pictures.

The existing error concealment techniques are mainly spatial error concealment techniques and temporal error concealment techniques as mentioned in the article “MPEG-2 Error Concealment Based on Block-Matching Principle” by Sofia Tsekeridou, et al., IEEE TRANSACTIONS ON CIRCUITS AND SYSTEMS FOR TECHNOLOGY, VOL. 10, Jun. 4, 2000.

Wherein the spatial error concealment techniques refer to that the information in a frame of picture is used to conceal errors when there is an erroneous picture area in the frame of picture. For example, errors in the erroneous picture area are concealed by using a valid (errorless) neighboring picture area of the same size as the erroneous picture area in the frame of picture. The temporal error concealment techniques refer to that the information in a reference picture of a frame of picture is used to conceal errors when there is an erroneous picture area in the frame of picture.

The reference picture can be one frame or one frame of multiple frames of pictures before the erroneous picture, or one frame or one frame of multiple frames of pictures after the erroneous picture, and these reference pictures have been stored in a buffer.

In the two kinds of error concealment techniques mentioned above, although the effect of error concealment by using temporal methods is slightly better than the effect of error concealment by using spatial methods, they still have corresponding defects respectively.

Therefore, in the article “MPEG-2 Error Concealment Based on Block-Matching Principle” mentioned above, it is also mentioned that the two kinds of methods are combined to conceal erroneous picture areas so as to reduce the defects existing in a single error concealment method as much as possible.

The method of combining the two kinds of methods to conceal erroneous picture areas refers to that the spatial methods are used to conceal errors in erroneous picture areas in case that temporal information is relatively active; and the temporal methods are used to conceal errors in erroneous picture areas in case that spatial information is relatively active. However, the combination is only limited to be based on whether the temporal domain or the spatial domain is active, which tends to cause that spatial methods are used when temporal methods should be used to conceal errors, thus the effect of error concealment is decreased.

Therefore, there exists a need for providing a new apparatus and method for concealing errors in a video decoding process, so that temporal methods and spatial methods are combined more effectively to conceal errors in video pictures in the video decoding process.

### OBJECT AND SUMMARY OF THE INVENTION

The object of the invention is to provide an apparatus and method for concealing errors in a video decoding process in order to combine the temporal methods and the spatial methods more effectively to conceal errors in video pictures in the decoding process.

The method for concealing errors in a video decoding process according to the invention comprises the steps of: receiving one frame of video picture comprising an error-existing picture area and a neighboring picture area; searching a similar picture area to the neighboring picture area according to a predetermined condition in one frame of reference picture of the video picture; and concealing the existing errors by using the information in the video picture if the similar picture area is not found.

The method further comprises the step of: concealing the existing errors by using the information in the reference picture if the similar picture area is found.

The apparatus for concealing errors in a video decoding process according to the invention comprises a receiving means, a searching means and a spatial error concealment means. Wherein the receiving means is used to receive a frame of video picture comprising an error-existing picture area and a neighboring picture area. The searching means is used to search a similar picture area to the neighboring picture area according to a predetermined condition in one frame of reference picture of the video picture. The spatial error concealment means is used to conceal the existing errors using the information in the video picture if the similar picture area is not found.

The apparatus also comprises a temporal error concealment means which is used to conceal the existing errors by using the information in the reference picture if the similar picture area is found.

The method and apparatus for concealing errors in a video decoding process according to the invention are to, firstly, search the information in a reference picture of a video picture for concealing an erroneous picture area in the video picture and, in case that the information is not found according to a predetermined condition, conceal errors by using the information in the video picture; and to conceal errors by using the information in the reference picture of the video picture in case that the information is found according to a predetermined condition.

Therefore, the present invention avoids the defect that the spatial methods are used to conceal errors while temporal methods should be used to conceal errors. With the method of the invention, even the temporal domain is active (for example, scene change, too much difference between the information in the reference picture and that in the error-existing video picture, etc.), errors can be concealed by using the temporal methods as long as the information for concealing errors can still be found in the reference picture. For example, there is a same person in two successive frames of pictures with the background changing from a desert to a prairie. Although the scene has completely changed (temporal domain is active), however, in case that the person' clothes are the same, the information for concealing errors can still be found in the reference picture (in a manner of temporal error concealment) if the erroneous picture area occurs on the person's clothes.

The other objects and achievements of the invention will be obvious and the invention will also be better understood with reference to the following description taken in conjunction with the drawings and the claims.

### BRIEF DESCRIPTION OF THE DRAWINGS

The present invention will be explained in detail by way of example with reference to the drawings, in which:

FIG. 1 is a schematic diagram of the apparatus for concealing errors in a video decoding process according to an embodiment of the invention.

FIG. 2 is a flow chart of the method for concealing errors in a video decoding process according to an embodiment of the invention.

FIG. 3 is a flow chart of searching for a similar picture area according to an embodiment of the invention.

FIG. 4 is a schematic diagram of concealing an erroneous picture area by using the temporal method according to an embodiment of the invention.

The same reference numerals represent the similar or the same features and functions in all the drawings.

### DETAILED DESCRIPTION OF THE INVENTION

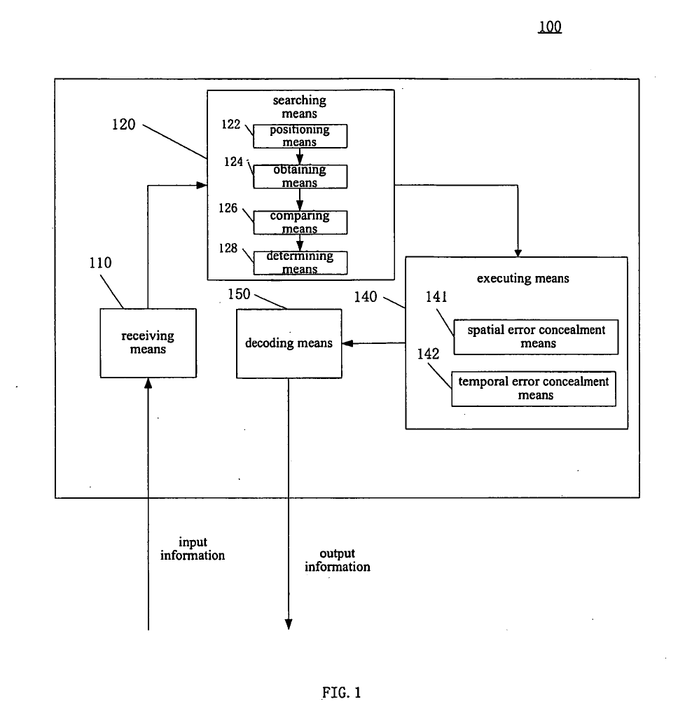

FIG. 1 is a schematic diagram of the apparatus for concealing errors in a video decoding process according to an embodiment of the invention. Apparatus 100 is used to conceal errors of the received video picture information.

The apparatus 100 comprises a receiving means 110, a searching means 120 and an executing means 140.

The receiving means 110 is used for receiving a frame of video picture which comprises one or more error-existing picture areas and one or more neighboring picture areas of each of the error-existing picture areas.

The neighboring picture area can be an immediately adjacent picture area right above, right below, to the left or to the right of the erroneous picture area. Assuming that the size of the erroneous picture area is 16*16, the neighboring picture area is also 16*16, and the neighboring picture area is a valid neighboring picture area, with the term “valid” meaning there is no error.

The searching means 120 is used to search a similar picture area to the neighboring picture area in one frame of reference picture of the video picture according to a predetermined condition.

The searching means 120 comprises a positioning means 122, an obtaining means 124, a comparing means 126 and a determining means 128.

The positioning means 122 is used for determining a corresponding picture area of the neighboring picture area in the reference picture.

The obtaining means 124 is used for obtaining the sum of the absolute values of the pixel differences between each particular picture area in the predetermined picture zone containing the corresponding picture area and the neighboring picture area, and the particular picture area is of the same size as the neighboring picture area.

The comparing means 126 is used for comparing the smallest sum of the absolute values of all the sums of the absolute values with a preset threshold.

The determining means 128 is used for determining whether the particular picture area with the sum of the absolute values is the similar picture area according to the result of the comparison and the predetermined condition.

Wherein, the predetermined condition can be that the particular picture area with the smallest sum of the absolute values is not the similar picture area if the smallest sum of the absolute values is greater than the preset threshold; and the particular picture area with the smallest sum of the absolute values is the similar picture area if the smallest sum of the absolute values is smaller than the preset threshold.

The preset threshold can be provided in advance by the provider through test and is usually set according to the size of the error-existing picture area. For example, the size of an erroneous picture area is 16*16, and the preset threshold can be set to 4*16*16.

Wherein, the predetermined picture zone is a predetermined zone centered on the corresponding picture area and expanding to the surroundings, and the size of the zone can be preset by the provider and usually can be 128*128. A predetermined zone of corresponding size can also be chosen according to the size of the error-existing picture area. For example, for an erroneous picture area with the size of 16*16, the predetermined zone can be set to 128*128. It can also be searched in the whole reference picture, but in this case, the searching takes too much time.

The reference picture can be one frame or one frame of multiple frames of pictures before the erroneous picture, or one frame or one frame of multiple frames of pictures after the erroneous picture, which is mainly an I-frame picture or a P-frame picture, and these reference pictures have been stored in a buffer.

The executing means 140 comprises a spatial error concealment means 141 and a temporal error concealment means 142. The spatial error concealment means 141 is used to conceal the existing errors by utilizing the information in the erroneous video picture in case that the similar picture area mentioned above is not found. The temporal error concealment means 142 is used to conceal the existing errors by utilizing the information in the reference picture in case that the similar picture area mentioned above is found.

Wherein the spatial error concealment techniques refer to that the information in a frame of picture is used to conceal errors when there is an erroneous picture area in the frame of picture. For example, errors in the erroneous picture area are concealed by using a valid (errorless) neighboring picture area of the same size as the erroneous picture area in the frame of picture. The temporal error concealment techniques refer to that the information in the reference picture of a picture is used to conceal errors when there is an erroneous picture area in the frame of picture.

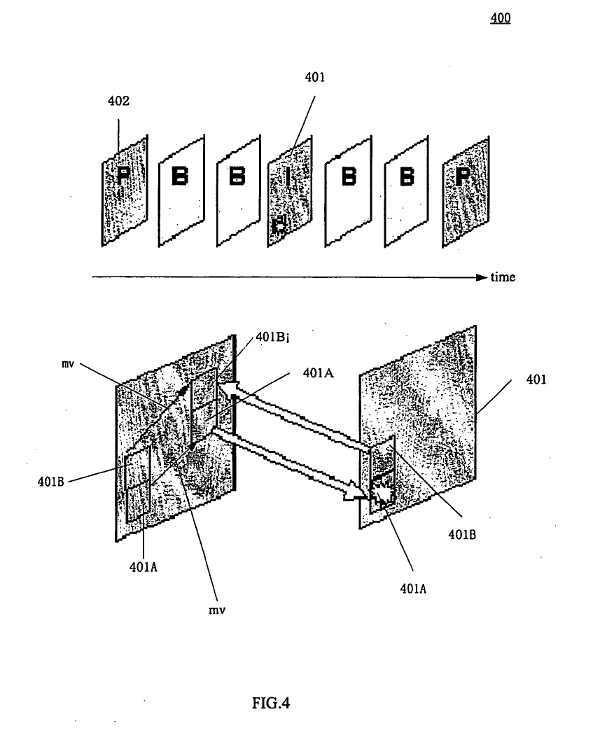

Please refer to the mentioned article “MPEG-2 Error Concealment Based on Block-Matching Principle” and the following introduction of FIG. 4 respectively for the detailed error concealment processes of the spatial error concealment means 141 and the temporal error concealment means 142.

The apparatus 100 also comprises a decoding means 150 for decoding video pictures after error concealment. The decoding means 150 can be one kind of existing decoding means.

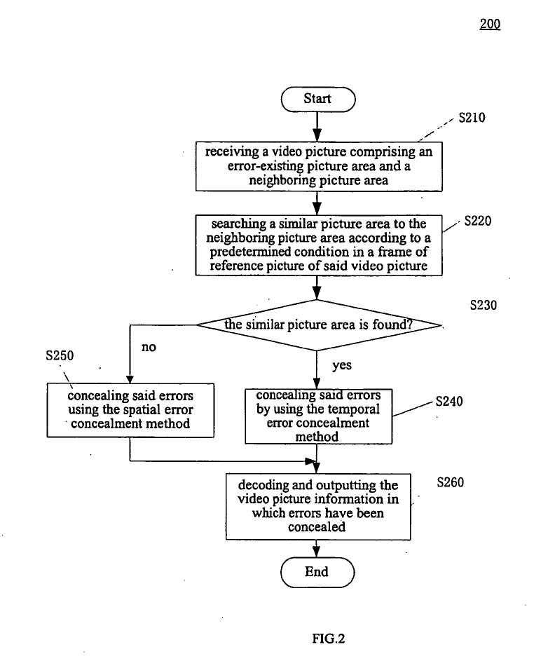

FIG. 2 is a flow chart of the method for concealing errors in a video decoding process according to an embodiment of the invention. Firstly, a video picture is received, and the video picture comprises an error-existing picture area and a neighboring picture area (step S120). Wherein the video picture can also comprise more than one erroneous picture areas and one or more neighboring picture areas of each of the error-existing picture areas.

The neighboring picture area can be an immediately adjacent picture area right above, right below, to the left or to the right of the erroneous picture area. Of course, the neighboring picture area can also be adjacent to the erroneous picture area in other ways. Assuming the size of the erroneous picture area is 16*16, then the neighboring area is also 16*16, and the neighboring picture area is a valid neighboring picture area, with the term “valid” meaning there is no error.

Furthermore, the neighboring picture area can also be different from the erroneous picture area in size. In the present embodiment, the neighboring picture area is an immediately adjacent 16*16 macro-block right above the erroneous picture area.

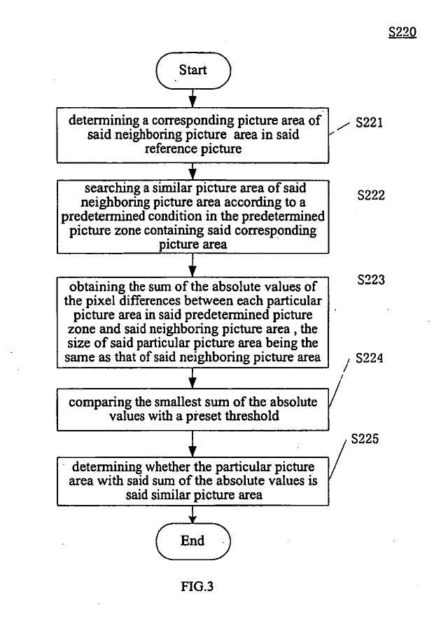

Secondly, searching for a similar picture area to the neighboring picture area in a frame of reference picture of the video picture according to a predetermined condition (step S220, please refer to the introduction of FIG. 3 for the explanation of the detailed process and the predetermined condition). The reference picture can be one frame or one frame of multiple frames of pictures before the erroneous picture, or one frame or one frame of multiple frames of pictures after the erroneous picture, which is mainly an I-frame picture or a P-frame picture, and these pictures have been stored in a buffer.

Next, it is determined whether the similar picture area is found in the step mentioned above (step S230, please refer to the introduction of FIG. 3 on how the determination is made in detail).

If the result of step S230 is negative, i.e. the similar picture area is not found, the information in the video picture is used to conceal the existing errors (step S250). For example, errors in the erroneous picture area are concealed by using a valid (errorless) neighboring picture area of the same size as the erroneous picture area in the frame of picture.

If the result of step S230 is positive, i.e. the similar picture area is found, the information in the reference picture is used to conceal the existing errors (step S240). Wherein the similar picture area is generally used to find an error-correcting picture area corresponding to the similar picture area in the reference picture according to the neighboring relation between the error-existing picture area and the neighboring picture area, and the information in the error-correcting picture area is used to conceal the existing errors. Please refer to the introduction of FIG. 4 for the detailed process of concealing errors.

Finally, the error-concealed video picture is decoded and output (step S260).

FIG. 3 is a flow chart of the process of searching for a similar picture area according to an embodiment of the invention. The flow chart is a decomposed flow chart of step S220 of searching for a similar picture area in FIG. 2.

Firstly, a corresponding picture area of the neighboring picture area is determined in the reference picture (step S221). The corresponding picture area is located at the corresponding position in the previous reference video picture to which the position of the neighboring picture area in the video picture is shifted.

In the present embodiment, the sizes of the neighboring picture area, the corresponding picture area, the particular picture area and the similar picture area are all the same as that of the erroneous picture area, for example, they are all 16*16, etc.

Next, according to the neighboring picture area, the similar picture area is searched for in the predetermined picture zone containing the corresponding picture area according to the predetermined condition (step S222).

Wherein the predetermined picture zone is a predetermined zone centered on the corresponding picture area and expanding to the surroundings, the size of which can be preset by the provider and can usually be 128*128; a predetermined zone of corresponding size can also be chosen according to the size of the error-existing picture area, for example, for an erroneous picture area with the size of 16*16, the predetermined zone can be set to 128*128; and it can also be searched for in the whole reference picture, but in this case, the searching takes too much time. The predetermined zone is 128*128 in the present embodiment.

Afterwards, the sum of the absolute values of the pixel difference between each particular picture area in the predetermined picture zone and the neighboring picture area is obtained, the size of the particular area being the same as that of the neighboring picture area (step S223). Wherein the particular area is formed by dividing the predetermined picture zone into several areas of the same size as the neighboring area.

According to the steps mentioned above, now taking the Y in the Y (luminance), U (chromatic information in color information), V (chromatic aberration information in color information) format as an example to explain how to obtain the sum of the absolute values of pixel difference between the neighboring picture area and each particular picture area. For example, if the size of the neighboring picture area is 16*16 and the size of the particular picture area is also 16*16, the sum of the absolute values of all the pixel differences between the two areas can be obtained in the following way: obtaining a difference value by subtracting one corresponding pixel value of the 256 pixels in the similar picture area from each pixel value of the 256 pixels in the neighboring picture area; then obtaining 256 absolute values by taking the absolute value of each difference value; adding up the 256 absolute values, then DIFF, the sum of the absolute values of the differences above, can be obtained.

The step S222 and step S223 above are all realized with the support of a motion estimation algorithm. In the motion estimation, the DIFF can be represented by an SAD (sum of absolute difference) in the following equation:

$$DIFF = S A D = {\sum }_{x = 1}^{L} {\sum }_{y = 1}^{H} \vert {B}_{ma} ( x , y ) - {B}_{rf} ( x , y ) \vert$$

The DIFF can also be represented by the sum of the square values of all the pixel differences.

As for the details of the motion estimation algorithm mentioned above, please refer to the article “Highly Efficient Predictive Zonal Algorithms for Fast Block-Matching Motion Estimation” by Lexis M. Tourapis, Oscar C. Au, and Ming L. Liou, IEEE TRANSACTIONS ON CIRCUITS AND SYSTEMS FOR VIDEO TECHNOLOGY, Vol. 12, No. 10, October, 2002.

According to the obtained DIFF corresponding to each particular picture area, the smallest DIFF of all the DIFF values is compared with a preset threshold (step S224). The preset threshold can be provided in advance by the provider through test and is usually determined by the size of the error-existing picture area. For example, for an erroneous picture area with the size of 16*16, the preset threshold can be set to 4*16*16, in which 4 is the average luminance (in the Y format) difference.

Finally, it is determined whether the particular area to which the DIFF corresponds is the similar picture area of the neighboring picture area according to the result of the comparison (step S225).

In the steps mentioned above, the particular picture area with the smallest sum of the absolute values is not the similar picture area if the smallest sum of the absolute values DIFF is greater than the preset threshold. And the particular picture area with the smallest sum of the absolute values is the similar picture area if the smallest sum of the absolute values DIFF is smaller than the preset threshold.

Therefore, the predetermined condition can be that the particular picture area with the smallest sum of the absolute values is not the similar picture area if the smallest sum of the absolute values is greater than the preset threshold; and the particular picture area with the smallest sum of the absolute values is the similar picture area if the smallest sum of the absolute values is smaller than the preset threshold.

When the smallest sum of the absolute values DIFF is smaller than the preset threshold, a vector and a position relation can be obtained between the similar picture area and its corresponding neighboring picture area, so as to find an error-correcting picture area according to the vector, the position relation and the neighboring relation between the erroneous picture area and the neighboring picture area in case that the temporal error concealment method is used to conceal the existing errors, and the existing errors are concealed according to the information in the error-correcting picture area.

The method and apparatus for concealing errors in a video decoding process according to the invention are to, firstly, search in a reference picture of a video picture for the information for concealing an erroneous picture area in the video picture and, in case that the information is not found according to a predetermined condition, conceal errors by using the information in the video picture; and to conceal errors by using the information in the reference picture of the video picture in case that the information is found according to a predetermined condition.

Therefore, the present invention avoids the defect that the spatial methods are used to conceal errors while the temporal methods should be used to conceal errors. With the method of the invention, even the temporal domain is active (for example, scene change, too much difference between the information in the reference picture and that in the error-existing video picture, etc.), errors can be concealed by using temporal methods as long as the information for concealing errors can still be found in the reference picture. For example, there is a same person in two successive frames of pictures with the background changing from a desert to a prairie. Although the scene has completely changed (temporal domain is active), however, in case that the person' clothes are the same, the information for concealing errors can still be found in the reference picture (in a manner of temporal error concealment) if the erroneous picture area occurs on the person's clothes.

FIG. 4 is a schematic diagram of concealing an erroneous picture area by using the spatial method in a video decoding process of an embodiment of the invention. The diagram explains schematically how to perform step S220, step S230 and step S240 in FIG. 2 in a graphic way. The following description will be done by taking a P-frame picture as the reference picture.

The error-existing picture area in a frame of erroneous 1-frame video picture 401 is 401A. The neighboring picture area of the erroneous picture area is 401B. In a P-frame reference picture 402 of the erroneous I-frame video picture 401, the similar picture area 401B′ corresponding to the neighboring picture area is found in a predetermined zone centered on the corresponding picture area of the reference picture to which the neighboring picture area 401B is shifted. Then a motion vector mv is determined through the position relation between the corresponding picture area and the similar picture area 401B′.

Wherein the process of searching for the similar picture area 401B′ in a predetermined zone is realized in the following way: firstly the predetermined zone is divided into multiple particular picture areas of the same size as the neighboring picture area; then the sum of the absolute values of the pixel differences between each particular picture area and the neighboring picture area is obtained; afterwards, the smallest sum of the absolute values is chosen from the sums of the absolute values and compared with the preset threshold; after the comparison, the particular picture area to which the smallest sum of the absolute values corresponds is the similar picture area 401B′ if the smallest sum of the absolute values is smaller than the preset threshold.

An error-correcting picture area 401A′ is determined according to the motion vector and the neighboring position relation between the error-existing picture area 401A and the neighboring picture area 401B. And the error-correcting picture area 401A′ is duplicated to conceal the error-existing picture area 401A.

In the invention, there can be one, two or more the valid neighboring areas, such as picture areas above, below, on the left and on the right of the error-existing picture area. The above description is done only taking one neighboring picture area as the example. If two or more neighboring picture areas are used for searching and more than one similar picture areas with one-to-one correspondence to the respective neighboring picture areas are found in a searching process, the similar picture area with the smallest sum of the absolute values of the pixel differences is used to determine the final error-correcting picture area, and also a similar picture area to which the mean or the median of the corresponding motion vectors corresponds can be used to determine the final error-correcting picture area.

The sum of the absolute values of the pixel differences between the neighboring picture area and the corresponding similar picture area mentioned above can be replaced by the sum of square of the pixel differences.

In the case of multiple neighboring picture areas obtained as mentioned above, if the number of the obtained similar picture areas and the number of the neighboring picture areas used for searching differ too much, for example, the corresponding similar picture area is found only for one neighboring picture area among 4 neighboring picture areas used for searching, usually it can be considered that the reference picture and the erroneous picture differ too much, thus the spatial method is chosen to conceal errors. In contrast, if the number of the found similar picture areas is close to the number of the neighboring picture areas used for searching, for example, 3 out of 4 are found, usually it can be considered that the reference picture and the erroneous picture are similar, and the temporal method is chosen to conceal errors.

Although the present invention has been described in conjunction with specific embodiments, it is obvious for those skilled in the art to do a lot of substitutions, modifications and variations according to the description above. Therefore, such substitutions, modifications and variations should be included in the present invention when they fall within the spirit and scope of the appended claims.

1. A method for concealing errors in a video decoding process, comprising the steps of:
(a) receiving a frame of video picture comprising an error-existing picture area and a neighboring picture area;
(b) searching a similar picture area to said neighboring area corresponds according to a predetermined condition in a frame of reference picture of said video picture for; and
(c) concealing said existing errors by utilizing the information in said video picture if said similar picture area is not found.

2. The method as set forth in claim 1, further comprising the step of:
(d) concealing said existing errors by utilizing the information in said reference picture if said similar picture area is found.

3. The method as set forth in claim 2, wherein step (d) comprises the steps of:
finding an error-correcting picture area corresponding to said similar picture area in said reference picture according to the neighboring relation between said error-existing picture area and said neighboring picture area; and
concealing said existing errors according to the information in said error-correcting picture area.

4. The method as set forth in claim 1, wherein step (b) comprises the steps of:
i. determining a corresponding picture area of said neighboring picture area in said reference picture; and
ii. searching for said similar picture area in the predetermined picture zone containing said corresponding picture area according to said predetermined condition.

5. The method as set forth in claim 4, wherein step (ii) comprises the steps of:
iii. obtaining the sum of the absolute values of the pixel differences between each particular picture area in said predetermined picture zone and said neighboring picture area, the size of said particular picture area being the same as that of said neighboring picture area;
iv. comparing the smallest sum of the absolute values with a preset threshold; and
V. determining whether the particular picture area with said sum of the absolute values is said similar picture area according to the result of the comparison and said predetermined condition.

6. The method as set forth in claim 5, wherein said predetermined condition is that the particular picture area with said smallest sum of the absolute values is not said similar picture area if said smallest sum of the absolute values is greater than said preset threshold.

7. The method as set forth in claim 5, wherein said predetermined condition is that the particular picture area with said smallest sum of the absolute values is said similar picture area if said smallest sum of the absolute values is smaller than said preset threshold.

8. An apparatus for concealing errors in a video decoding process, comprising:
a receiving means for receiving a frame of video picture comprising an error-existing picture area and a neighboring picture area; a searching means for searching a similar picture area to said neighboring picture area corresponds according to a predetermined condition in a frame of reference picture of said video picture; and
a spatial error concealment means for concealing said existing errors by using the information in said video picture if said similar picture area is not found.

9. The apparatus as set forth in claim 8, further comprising a temporal error concealment means for concealing said existing errors by using the information in said reference picture if said similar picture area is found.

10. The apparatus as set forth in claim 8, wherein said searching means comprises:
a positioning means for determining a corresponding picture area of said neighboring picture area in said reference picture;
an obtaining means for obtaining the sum of the absolute values of the pixel differences between each particular picture area in the predetermined picture zone containing said corresponding picture area and said neighboring picture area, the size of the particular picture area being the same as that of said neighboring picture area;
a comparing means for comparing the smallest sum of the absolute values with a preset threshold; and
a determining means for determining whether the particular picture area with said sum of the absolute values is said similar picture area according to the result of the comparison and said predetermined condition.

11. The apparatus as set forth in claim 10, wherein said predetermined condition is that the particular picture area with said smallest sum of the absolute values is not said similar picture area if said smallest sum of the absolute values is greater than said preset threshold.

12. The apparatus as set forth in claim 11, wherein said predetermined condition is that the particular picture area with said smallest sum of the absolute values is said similar picture area if said smallest sum of the absolute values is smaller than said preset threshold.
